(19) United States
(12) Patent Application Publication
(10) Pub. No.: US 2004/0127236 A1
(43) Pub. Date: Jul. 1, 2004

(54) Method and apparatus for text entry for electronic messaging

(76) Inventor: Manjirnath Chatterjee, Sunnyvale, CA (US)

Correspondence Address: VEDDER PRICE KAUFMAN & KAMMHOLZ, 222 N. LaSalle Street, Chicago, IL, 60601, US

(21) Appl. No.: 10/330,912

(22) Filed: Dec. 27, 2002

(51) Int. Cl. H04B 1/00

(52) U.S. Cl. 455/466; 455/566

(57) ABSTRACT

A method and apparatus for Thai language electronic messaging includes a keypad (102) having a plurality of keys (104) and a communication character database (108) storing a plurality of communication characters (184, 194) associated with a plurality of communication character menus (182, 192). The method and apparatus further includes a menu/character selector (106) coupled to the keypad (102), wherein upon depression of at least one key (104), the keypad (102) provides a menu selection signal (110) to the menu/character selector (106) and upon depression of another at least one key (104), the keypad (102) provides a communication character selection signal (112) to the menu/character selector (106). In response thereto, communication characters (184, 194) are displayed on the display (120) to create an electronic message.

### BACKGROUND OF THE INVENTION

The present invention relates generally to an electronic messaging system and more specifically to an electronic messaging text entry system utilizing an alphabetic textual representation for generating an electronic message.

With the growth of wireless devices, there is also concurrent growth in providing for electronic messaging, such as a short messaging system (“SMS”). A typical wireless device includes, but is not limited to, a cellular phone, a laptop computer, a desktop computer, personal digital assistant, a pager, a smart phone, or any other suitable device as recognized by one having ordinary skill in the art to receive communication. Other available messaging systems include extended messaging systems (“EMS”) and multi-media messaging system (“MMS”).

All messaging systems require the user to create a message to be communicated to another wireless device. One common example of generating a message is to use current available resources on the wireless device to construct a text message. To provide English-based text entry, the text may be entered using one of four possible data entry methods, a code method, a multi-tap method, a grid method and a predictive method.

The code method of data entry requires a user to first select one of a plurality of menus of letters, numbers and characters. Then, from the selected menu, a chosen character is selected, such as pressing the button “2” on a keypad of the wireless device to select a punctuation menu and the pressing the button “4” on the keypad to select an exclamation point.

The multi-tap method allows a user to enter text by depressing a selected key one or more times based on characters associated with the key, such as pressing the number “2” twice to generate the letter “B” on a commonly available telephone keypad. The multi-tap method typically requires the user to then wait a prescribed time period before entering another letter, such that the wireless device recognizes the user's acceptance of the previously entered character.

The grid method of consists of a visual display having a grid of the available characters, thereby allowing a user to navigate the grid and select the chosen character. This method requires a graphical display to illuminate the grid and often times may be cumbersome for an end user to continually navigate numerous characters, which also may not be readily visible based on a display area limitations.

The predictive method utilizes any of the above text entry method and combines a predictive analysis based on a corresponding library of predictive terms. For example, in conjunction with the multi-tap method, a user may enter the letters “h,” “e,” “l,” and a processor may determine that the user is attempting to enter the word “hello.” Therefore, using a combination of entered keystrokes with reference to a predictive library, the input of a text message may be improved by the wireless device predicting entered terms.

These methods work well in combination with many languages that have base construction using the English alphabet, such as English, French, Spanish, German. Languages having larger alphabets may be problematic for quick and efficient data entry. For example, the Japanese language contains a larger alphabet than the English alphabet, therefore a multi-tap method of data entry may not be efficient and the grid method may be too cumbersome, based on a large number of characters through which the user must navigate. Therefore, it may be advisable to use a code method of text entry allowing a user to enter a Japanese message by selecting a first menu of characters and then selecting a chosen character within the selected menu. Based on the size of the Japanese alphabet, a standard ordering of alphabetic character must be provided, for example the ordering of Japanese characters as taught for learning to speak Japanese. One such example is associating all Kana characters to a number, such as the number “2.” Therefore, a user depresses the digit “2” and then selects from the standard order of Kana characters, e.g. Ka, Ki, Ku, Ke and Ko which are selectively mapped to various keys, such as 1-5. Due to the large volume of Japanese characters, previous multi-tap methods of text entry had to be based on a standard sequence of characters so the user may known or reasonably ascertain the correct character for entry.

Furthermore, in a typical messaging system, timing of text entry is an important factor. Truncated words and other forms of slang have emerged to improve the speed of communication using a wireless device messaging system.

### BRIEF DESCRIPTION OF THE DRAWINGS

The invention will be more readily understood with reference to the following drawings wherein:

FIG. 1 illustrates an example of an apparatus for text entry for electronic messaging;

FIG. 2 illustrates another example of an apparatus for text entry for electronic messaging;

FIG. 3 illustrates an example of a method for text entry for electronic messaging;

FIG. 4 illustrates an example of a method for text entry for electronic messaging;

FIG. 5 illustrates an example of a Thai language code-method database; and

FIG. 6 illustrates another example of a Thai language code-method database.

### DETAILED DESCRIPTION OF THE INVENTION

Generally, a method and apparatus for text entry for electronic messaging includes receiving a menu selection signal to select a selected character menu from a plurality of character menus. Each character menu includes one or more communication characters, which may be an English-alphabet letter or a non-English-alphabet letter, such as, but not limited to, a Thai character, an asterisk or an exclamation point. The communication characters within the character menus are arranged in a non-standard order, such as utilizing an ordering mechanism outside of the language specific standardized ordering. For example, the Thai language has no specific standard ordering, therefore using an alphabetical or phonetic ordering form constitutes a non-standard ordering form for the Thai language. The method and apparatus further includes receiving a character selection signal to select a selected communication character from the plurality of communication characters from the selected character menu.

The apparatus includes a keypad allowing for depression of one or more keys for the generation of the menu selection signal and the generation of the character selection signal. The method and apparatus further includes displaying the selected communication character on a display screen. The method may be repeated until the complete electronic message is entered, whereupon the message may then be transmitted.

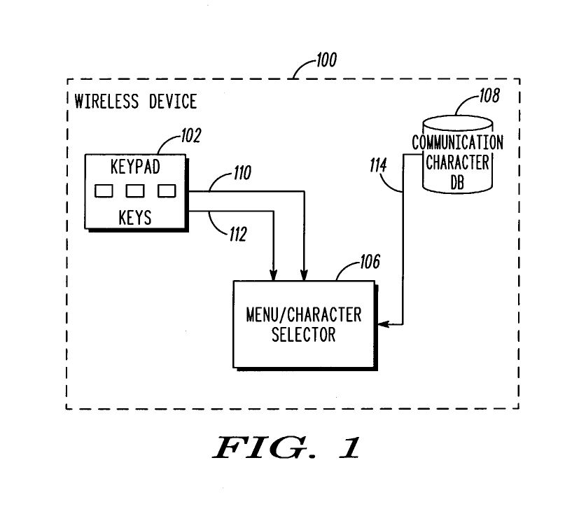

More specifically, FIG. 1 illustrates a wireless device 100 for text entry for electronic messaging having a keypad 102 with a multiple number of keys 104. The wireless device 100 includes a menu/character selector 106 and a communication character database 108. The menu/character selector 106 may be implemented in hardware, software or a combination thereof. The communication character database 108 may be, but not limited to, a single memory, a plurality of memory locations, shared memory, CD, DVD, ROM, RAM, EEPROM, optical storage, or any other non-volatile storage capable of storing digital data.

Upon depression of a first key, such as 104, a menu selection signal 110 is provided to the menu/character selector 106. Upon depression of a second key, such as 104, a communication character signal 112 is provided to the menu/character selector 106. In one embodiment, the menu selection signal 110 and the communication character signal 112 may be in response character menus and communication characters 114 provided from the communication character database 108 to the menu/character selector 106. In one embodiment, the communication character database 108 includes the plurality of character menus having multiple communication characters, wherein the communication characters are provided in a non-standard order.

As discussed above, the non-standard order includes an ordering of the characters not typically found, whereas a typical order may be an alphabetical order for an English alphabet and a class learning designation (e.g. Kana class) for a Japanese alphabet. As discussed below, in one embodiment, the character database 108 may include a Thai character database which does not have any acceptable standard formatting for ordering of the characters. Therefore, in the embodiment of a Thai character database, a non-standard order may include an alphabetical order, as these characters are not standardized in an alphabetical manner. Furthermore, another non-standard order may include a phonetic ordering scheme. In alternative embodiments for other languages, such as the English alphabet, the non-standard order may include letters and numbers relative to a QWERTY keyboard, vowel and constant designation, or any other suitable non-standard ordering as recognized by one having ordinary skill in the art.

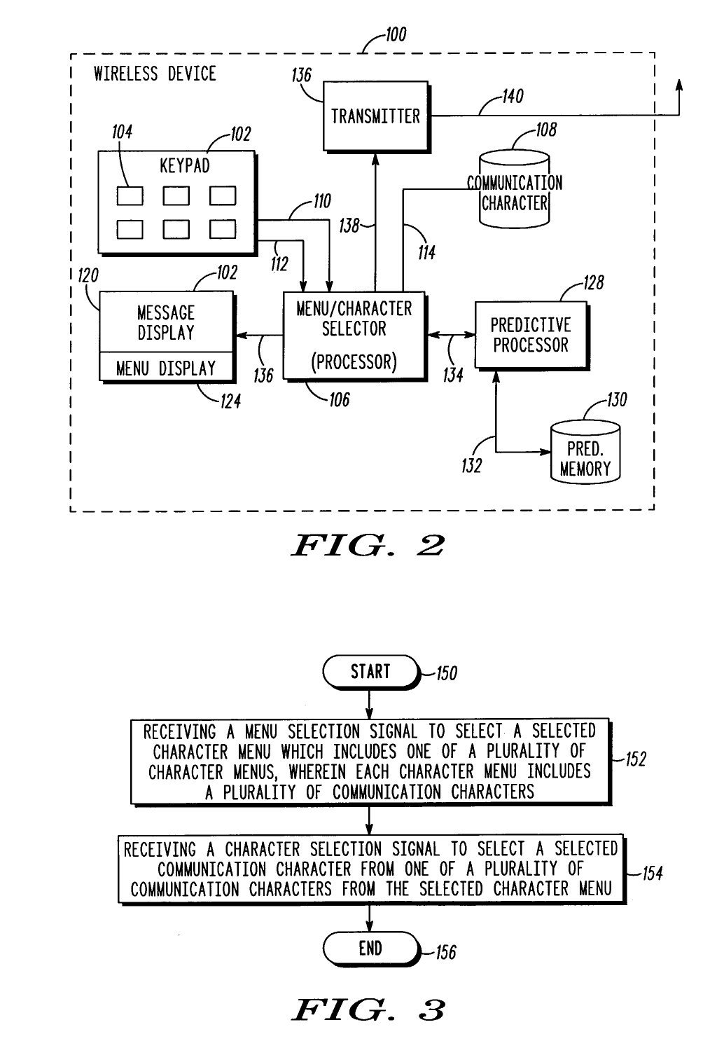

FIG. 2 provides further illustration of the wireless device 100 having the keypad 102 with multiple keys 104 disposed thereon. The wireless device 100 includes the menu/character selector 106, which may be a processor, but not limited to, a single processor, a plurality of processors, a DSP, a microprocessor, ASIC, state machine, or any other implementation capable of processing and executing software or discrete logic or any suitable combination of hardware, software and/or firmware. The term processor should not be construed to refer exclusively to hardware capable of executing software, and may implicitly include DSP hardware, ROM for storing software, RAM, and any other volatile or non-volatile storage medium.

The wireless device 100 includes a display 120 having both a message display 122 and a menu display 124. In one embodiment, the message display 122 may be a top portion of the display 120, which includes any type of visual display, such as a liquid crystal display and the menu display 124 may be a bottom portion of the display 120. The message display 122 is capable of displaying the electronic message as it is being entered and the menu display 124 is capable of displaying the character menus. The menu/character selector 106 is coupled to the display 120 and provides a display signal 126 for being displayed thereon.

In one embodiment, the wireless device 100 provides the display signal 126 providing for the display of the possible character menus on the menu display 124. An end user may view the menus and select one of the keys 104 to select a corresponding menu, providing the menu selection signal 110 to the menu/character selector 106. The menu/character selector 106 then provides the display signal 126 to the menu display 124 displaying the corresponding communication characters available for selection. In one embodiment, the menu display 124 also displays corresponding keypad key 104 numbers, such that the user may then depress one of the keys 104, wherein the communication character selection signal 112 is provided to the menu/character selector 106. The menu/character selector may then provide the display signal 126 having the chosen communication character for display on the message display 122 and allow for the original display of menus on the display menu 124. This process may be repeated until the message is completed.

The menu/character selector 106 is also coupled to a predictive processor 128. The predictive processor 128 is operably coupled to a predictive memory 130 to provide and receive predictive signals 132 therefrom. The predictive processor 128 may be, but not limited to, a single processor, a plurality of processors, a DSP, a microprocessor, ASIC, state machine, or any other implementation capable of processing and executing software or discrete logic or any suitable combination of hardware, software and/or firmware. The term processor should not be construed to refer exclusively to hardware capable of executing software, and may implicitly include DSP hardware, ROM for storing software, RAM, and any other volatile or non-volatile storage medium. The memory 132 may be, but not limited to, a single memory, a plurality of memory locations, shared memory, CD, DVD, ROM, RAM, EEPROM, optical storage, or any other non-volatile storage capable of storing digital data for use by the processor 128.

In one embodiment, the menu/character selector 106 provides a communication character selection signal 134 to the predictive processor 128. The communication character selection signal may be a representation of the actual communication character, a representation of the key 104 entries corresponding to the menu selection signal 110 and the communication character selection signal 112, or any other suitable input signal for use by the predictive processor to determine the selected communication character. Based on a comparison of the communication character selection signal 104 and predictive signals 130 from the predictive memory 132, the predictive processor may generate a word estimate that may be provided to the message display 122. In another embodiment, the predictive processor 128 may also provide generated words to the predictive memory 132 for later use by the predictive processor 128.

The wireless device 100 also includes, in one embodiment, a transmitter 136 that receives a message signal 138 from the menu/character selector 106. Once a user has completed entering the electronic message, the menu/character selector 106 provides the message signal 138, such that the transmitter 136 may thereupon generate a transmission signal 140. In one embodiment, the transmission signal 140 may be provided to another wireless device, for engaging in a messaging system. The transmitter 136 may encode the message signal 138 in any suitable transmission encoding scheme capable of allowing wireless transmission thereof.

FIG. 3 illustrates steps of a method for text entry for electronic messaging. The method begins, step 150, by receiving a menu selection signal to select a selected character menu which includes one of a plurality of character menus, wherein each character menu includes a plurality of communication characters, step 152. The next step of the method includes receiving a character selection signal to select a selected communication character from one of a plurality of communication characters from the selected character menu, step 154. As discussed above with regards to FIG. 2, the menu selection signal 110 and the communication character selection signal 112 are received from a keypad 102. Thereupon, in one embodiment, the method is complete, step 156.

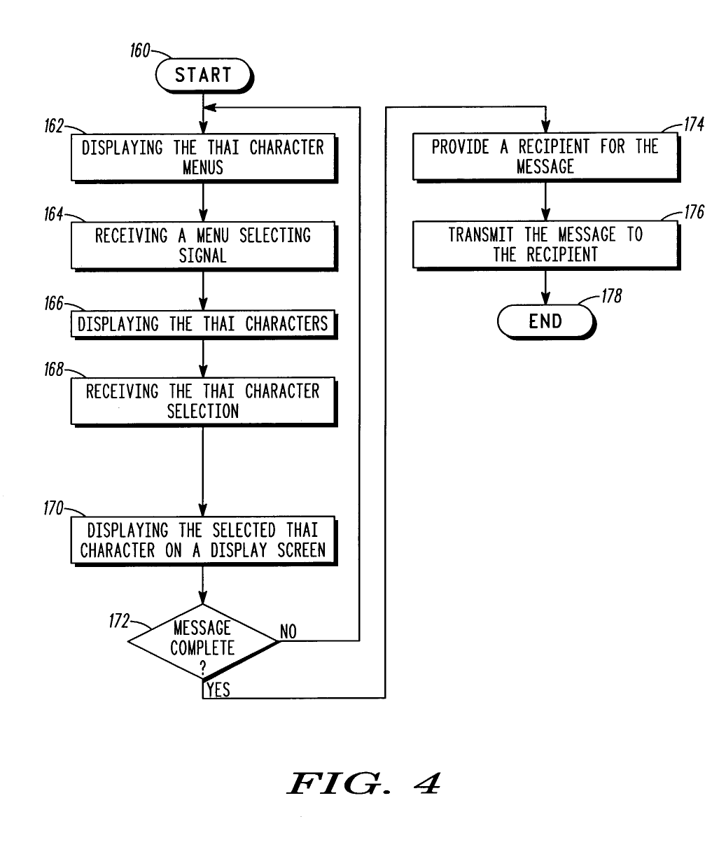

FIG. 4 illustrates another example of the steps of method for text entry for electronic messaging using the Thai language to generate a Thai-based electronic message. The method begins, step 160, by displaying Thai character menus, step 162. As discussed below, the Thai character menus provide menus of different Thai characters. The next step is receiving a menu selection signal, step 164. In one embodiment, the menu selection signal 110 is provided from the keypad 102. Thereupon, the next step is displaying the Thai characters on a display, step 166. As discussed above, the Thai characters are displayed on the menu display 124. The next step of the method is receiving a Thai character selection signal, step 168. As discussed above, the Thai character selection signal 112 is provided from the keypad 102 by the depression of one of the keys 104. Thereupon, step 170, the selected Thai character is displayed on a display screen, such as message display 122.

The method requires a decision of whether or not the Thai message is complete, step 172. If the message is not complete, thereupon requiring at least one more Thai character to be entered, the method repeats steps 162 through 170 until the message has been completely entered. Upon completion of the message, a message-complete signal may be received, such as the selection of a specific key 104 on the keypad to designate that the contents of the message have been entered. As recognized by one having ordinary skill in the art, the message completion signal may be any suitable signal provided from the keypad to designate the message has been fully composed.

In one embodiment, the method includes providing a recipient for the message, such as, but not limited to, an electronic mail address, a wireless device identifier, such as a telephone number or a universal resource locator, step 174. As such, upon identification of a recipient, the message may be transmitted to the recipient, step 176. Thereupon, in one embodiment, the method is complete, step 178.

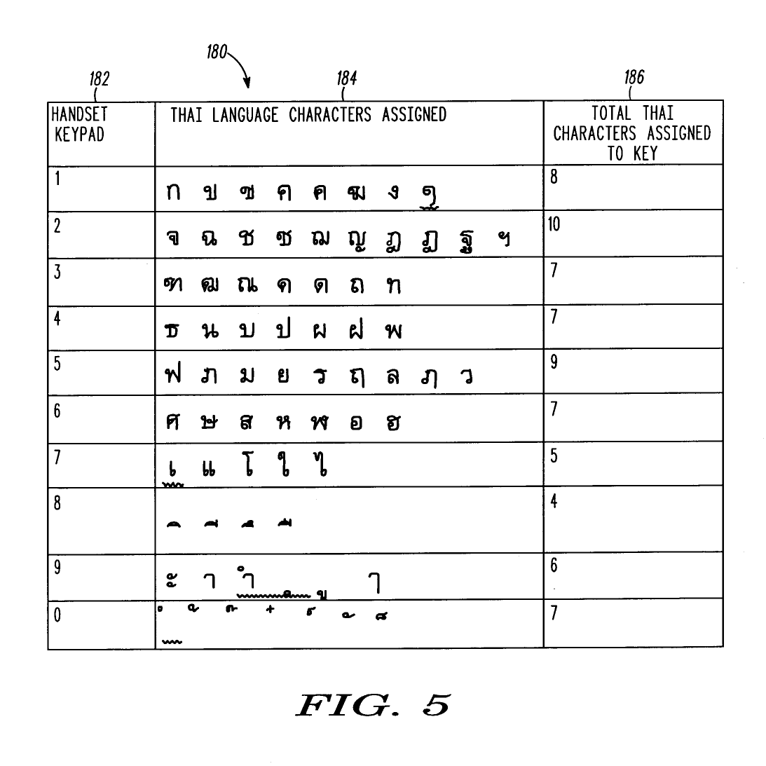

FIG. 5 illustrates an example of a table 180 of Thai character based, in one embodiment, on an alphabetical assignment. The table 180 includes a handset keypad list 182 which corresponds to keys entered on a numerical keypad, such as keypad 102. The table 180 further includes the Thai characters 184 assigned to each particular key 104 of the keypad 102, as illustrated in FIGS. 1-2. The table 180 also illustrates the number of Thai characters assigned to each key 184.

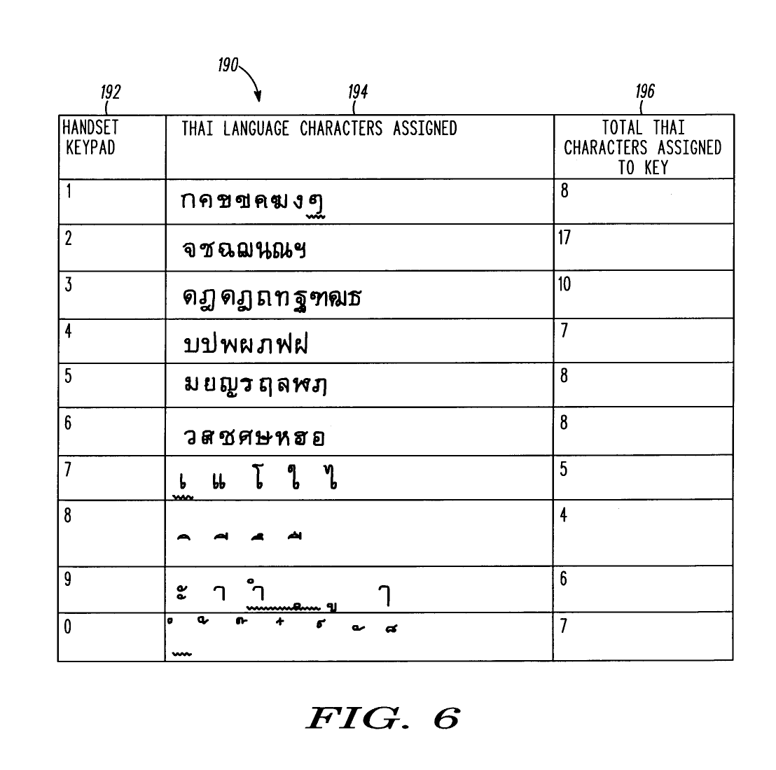

FIG. 6 illustrates an example of a table 190 of Thai character based, in one embodiment, on a phonetic assignment. The table 190 includes a handset keypad list 192 which corresponds to keys entered on a numerical keypad, such as keypad 102. The table 190 further includes the Thai characters 194 assigned to each particular key 104 of the keypad 102, as illustrated in FIGS. 1-2. The table 180 also illustrates the number of Thai characters assigned to each key 194.

With respect to the method and apparatus for Thai language electronic messaging, a user may select the key 182, 192 to select a selected menu 184, 194. The selected menu 184, 194 is then displayed, allowing for the selection of one of the particular Thai characters based on entering a corresponding key 104 of the keypad 102. Using a code method of text entry, a Thai message may be quickly and efficiently entered by the multiple depression of various keys 104 of the keypad 102, wherein the display 120 displays the different menus of Thai characters and the actual characters within the Thai menu. The method and apparatus further provides for improved text entry by streamlining text entry process by providing for a two key-press association for each of the different Thai characters of the numerous characters of the Thai language alphabet.

It should be understood that there exists implementations of other variations and modifications of the invention and its various aspects, as may be readily apparent to those of ordinary skill in the art, and that the invention is not limited by the specific embodiments described herein. For example, the character menus and the Thai characters within the character menu may be arranged in any particular order to provide for improved speed of text entry. It is therefore contemplated and covered by the present invention, any and all modifications, variations, or equivalence to fall within the spirit and scope of the basic underlying principals disclosed and claimed herein.

What is claimed is:

1. A method for text entry for electronic messaging, the method comprising:
(a) receiving a menu selection signal to select a selected character menu which includes one of a plurality of character menus having a plurality of communication characters such that the plurality of communication characters in each of the plurality of character menus are arranged in a non-standard order; and
(b) receiving a character selection signal to select a selected communication character from one of a plurality of communication characters from the selected character menu.

2. The method of claim 1 further comprising:
(c) displaying the selected communication character on a display screen.

3. The method of claim 2 further comprising:
(d) repeating steps (a) and (b) to compose a message which includes one or more words;
(e) providing a recipient for the message;
(g) transmitting the message to the recipient.

4. The method of claim 1 wherein the communication characters are Thai characters and the plurality of character menus include a first menu of Thai character arranged alphabetically and a second menu of Thai characters arranged phonetically.

5. The method of claim 1 further comprising:
prior to step (a), displaying the Thai character menus; and
prior to step (b), displaying the Thai characters.

6. The method of claim 5 wherein the display is disposed on a wireless device and the menu selection signal and character selection signal are entered through a keypad on the wireless device.

7. A wireless device comprising:
a keypad having a plurality of keys;
a communication character database capable of storing a plurality of communication characters in a plurality of character menus, such that each of the plurality of character menus includes a plurality of characters arranged in the character menus in a non-standard order; and
a menu/character selector coupled to the keypad, such that the keypad, upon the depression of one of the keys, provides a menu selection signal to the menu/character selector, whereupon another depression of one of the keys, provides a character selection signal to the menu/character selector.

8. The wireless device of claim 7 further comprising:
a menu display coupled to the menu/character selector such that the menu display displays each of the plurality of characters sets prior to the menu/character selector receiving the menu selection signal and displays each of the plurality of communication characters associated with a selected character set; and
a message display coupled to the menu/character selector such that the message display displays the message, which consists of one or more selected communication characters selected in response to the character selection signal.

9. The wireless device of claim 8 wherein the communication character database stores the plurality of character menus, which include a first menu of Thai characters arranged alphabetically and a second menu of Thai characters arranged phonetically.

10. The wireless device of claim 8 further comprising:
a processor capable of receiving a message-complete signal from the keypad; and
a transmitter operably coupled to the processor such that the message may be transmitted to a recipient upon the reception of the message-complete signal.

11. The wireless device of claim 8 wherein the message display and the menu display are disposed within a wireless device display.

12. The wireless device of claim 8 further comprising:
a predictive entry processor capable of monitoring the menu selection signal and the character selection signal; and
a predictive entry memory coupled to the predictive entry processor such that the predictive entry memory stores one or more predictive signals, wherein a predictive signal includes a combination of menu selection signals and character selection signals which correspond to a word estimate.

13. The wireless device of claim 12 wherein the predictive entry processor, upon recognition of the word estimate, through the combination of menu selection signals and the character selection signals, provides the word estimate to a display.

14. An apparatus for text entry for electronic messaging, the apparatus comprising:
a keypad having a plurality of keys;
a communication character database;
a memory storing executable instructions; and
a processor operably coupled to the keypad, the communication character database and the memory such that the processor may receive the executable instructions from the memory and, in response to the executable instructions:
receive a menu selection signal from the keypad to activate one of a plurality of character menus having a plurality of communication characters such that the plurality of communication characters in each of the plurality of character menus are arranged in a non-standard order; and
receive a character selection signal from the keypad to select one of the communication characters from the selected character menu.

15. The apparatus of claim 14 further comprising:
a display capable of receiving a display signal from the processor and in response to a menu display signal, displaying the plurality of character menus and in response to a character display signal, displaying the plurality of communication characters.

16. The apparatus of claim 15 further comprising:
a transmitter operably coupled to the processor such that a message composed through the reception of one or more menu selection signals and one or more character selection signals may be transmitted to a recipient device.

17. The apparatus of claim 14 wherein the communication character database stores the plurality of character menus, which include a first menu of Thai characters arranged alphabetically and a second menu of Thai characters arranged phonetically.

18. The apparatus of claim 14 further comprising:
a predictive entry processor capable of monitoring the menu selection signal and the character selection signal; and
a predictive entry memory coupled to the predictive entry processor such that the predictive entry memory stores one or more predictive signals, wherein a predictive signal includes a combination of menu selection signals and character selection signals which correspond to a word estimate.

19. The apparatus of claim 18 wherein the predictive entry processor, upon recognition of the word estimate, through the combination of menu selection signals and the character selection signals, provides the word estimate to a display.

20. The apparatus of claim 14 wherein the keypad, memory and processor are disposed within a wireless device.
